(19) United States
(12) Patent Application Publication
(10) Pub. No.: US 2012/0183701 A1
(43) Pub. Date: Jul. 19, 2012

(54) METHOD FOR PRODUCING A MARKED OBJECT

(76) Inventors: Heinz Pilz, Berlin (DE); Olaf Rehme, Hamburg (NL); Martin Schäfer, Berlin (DE)

(21) Appl. No.: 13/498,228

(22) PCT Filed: Sep. 16, 2010
(86) PCT No.: PCT/EP2010/063608

§ 371 Date: Mar. 26, 2012

(30) Foreign Application Priority Data
Sep. 25, 2009 (DE) 10 2009 043 597.2

(51) Int. Cl. C08J 7/04; B05D 5/00

(52) U.S. Cl. 427/504; 427/265

(57) ABSTRACT

A method produces a marked object. To be able to create markings in a particularly flexible way, it is provided that the object is produced by an additive production process, at least one marking being formed in the object during the additive production process. The method makes many degrees of freedom possible in the design of the marking. For example, the method makes it possible in a very simple way for two- or three-dimensional structures to be concealed within the object during the additive production process. In addition or as an alternative, production parameters can be varied, whether stochastically or deterministically, to produce variations in density. For example, a porous microstructure may be produced as a marking. It is also possible for basic material in the object to be left untreated or to be differently treated, so that it forms the marking.

### CROSS REFERENCE TO RELATED APPLICATIONS

This application is based on and hereby claims priority to International Application No. PCT/EP2010/063608 filed on Sep. 16, 2010 and German Application No. 10 2009 043 597.2 filed on Sep. 25, 2009, the contents of which are hereby incorporated by reference.

### BACKGROUND

As can be gathered for example from the German laid-open specification DE 10 2006 005 927 A1, every year companies incur economic damage in an order of magnitude of about five billion Euros due to product forgery and product piracy. Frequently in particular products which cater for attractive markets are copied and distributed by product pirates. The product pirates capitalize from the fact that their margin does not include the frequently very high initial development costs. Customers who use such product copies often run the risk of purchasing low-quality products which do not meet the specified requirements or have run through the respectively required qualification processes. These problems in particular relate to the market of spare-parts procurement for complex machines and systems, such as for example for gas and steam turbines. If, in violation of a contract, a customer uses a low-quality spare part which leads to failure of or damage to a system, the supplier faces the problem of having to prove this matter to the customer in order to protect the quality of the supplier's machine and system.

The process of visibly marking products for example by way of laser writing methods or of applying holograms has been known for a relatively long period of time. Providing identifiers by way of hidden markings, which cannot be readily detected by product pirates but for which the original producer can check using relatively simply, is also known.

A method for producing a marked object is known for example from the German patent specification DE 10 2006 030 365 B3. In this previously known method, a turbine blade is produced using a metal casting method, wherein a marking is cast into the turbine blade.

DE 102 19 983 A1 discloses that components produced using additive production methods, such as laser sintering, can be provided with a marking on the forming surface. Here, identification marks can be provided in the marking, for example, by co-forming elevated letters on the surface.

DE 43 33 546 C2 discloses that transparent objects can be marked with color inclusions. This is carried out by the component being produced from several layers, wherein among others a film is used as a layer, which film achieves the desired color effect. This film is not bonded only in the regions of the underlayering, where the marking is intended to be produced. In the remaining regions, the film is removed and the remaining film parts are enclosed by subsequent layers. The remaining film parts, which form the marking, can be recognized in the finished transparent component.

### SUMMARY

One possible object is to specify a method for producing a marked object, with which markings can be realized in a particularly flexible manner, for example at the same time also different marking types.

Accordingly, the inventors propose for the object to be produced by an additive production method, wherein at least one marking is formed in the object during the additive production method.

One advantage of the proposed method is that it enables a great number of degrees of freedom in the configuration of the marking. By way of example the method can be used to hide during the additive production method in a very simple manner two- or three-dimensional structures inside the object, for example in cavities. In addition or alternatively, during the additive production method production parameters can be varied, either stochastically or deterministically, in order to produce density fluctuations. In this case the density fluctuations constitute the marking. The additive production method provided thus permits the use of different marking individually or in combination with one another.

One further advantage of the method is that it can be carried out very quickly and cost effectively, because the object and the markings can be produced by the same method, that is to say simultaneously.

Additive production methods are already known per se from other fields of technology. Simply by way of example reference is made in this regard to the document “Wohlers Report 2008” (Terry T. Wohlers, Wohlers Associates Inc., Fort Collins, Colo., USA, ISBN 0-9754429-4-5). This document includes examples of how additive production methods can be implemented specifically and is incorporated herein by reference.

The at least one marking is preferably enclosed or embedded in the object.

In order to examine a marking contained in a marked object, various detection methods can be used. For example methods in which radiation passes through objects, for example on the basis of X-ray radiation with planar, or two-dimensional, resolution or on the basis of computer tomography with three-dimensional resolution, can be used in order to detect and image local density differences in the object.

Alternatively it is possible to use acoustic methods which identify boundary surfaces in areas with local density differences for example using ultrasound. Acoustic methods typically permit a three-dimensional resolution.

Alternatively or additionally it is possible to make visible markings using thermal methods. One such method to be mentioned in this regard is active thermography which enables two-dimensional resolution and represents differences in the local thermal conductivity and thus local density differences within the marked object.

Electromagnetic methods can also be used. Examples to be mentioned in this regard are inductive measurement methods, in which, for example using a moving sensor, a magnetic field is generated and the change in the magnetic field due to local density differences in the marked object is indicated by an induction voltage in a coil of the sensor.

Other magnetic detection methods are also suitable if for example magnetic material for marking the object is embedded in the object.

The marked object can be produced particularly simply and thus advantageously in a layer-wise fashion. Preferably a first powder layer is melted locally using an energy beam to form a first material layer; subsequently further powder layers are applied, layer by layer, onto the first material layer, which further powder layers are melted locally in each case to form further material layers. In this manner the marked object is formed by a multiplicity of individual layers placed one on top of the other.

Alternatively it is also possible to use liquid layers rather than powder layers, which liquid layers are cured locally using an energy beam such that the marked object is in this way composed from layers.

With particular preference, the marked object is produced in a metallic powder bed using a laser beam or electron beam. The laser or electron beam here serves for selectively melting the thin powder layers, which form the marked object after cooling.

In order to control the energy beam, preferably CAD data are processed which describe the object to be marked by way of a volume model or a surface model. For processing purposes, the CAD data are preferably converted, before or during the additive production process, to layer data, with each layer corresponding to a cross section of the object to be marked with finite layer thickness.

The cross-sectional geometry of the object to be marked is produced during the additive production method preferably by way of line-type exposure of the outer contours and an areal exposure of the cross sections to be filled. The line-type exposure is realized in the case of a point-shaped characteristic of the energy beam preferably by way of corresponding beam movement. Areal exposure can occur for example by carrying out line-type exposure processes in succession.

A marking can be formed particularly simply and thus advantageously by varying a production parameter or a plurality of production parameters during the additive production method, either stochastically or deterministically, and by forming the marking by way of a local change in the material properties inside the object, for example by way of a local density change.

According to one particularly preferred embodiment of the method, it is provided for a porous substructure to be produced in the object to be marked, for example in a cavity inside the object to be marked, and for the marking to be formed by the pore distribution of the porous substructure. In this embodiment it is possible to ascertain for example on the basis of a pore distribution stored in a database whether or not an object is an original object by comparing the pore distribution for the object to be examined with the pore distribution stored in the database for the original object: if the current pore distribution and the stored pore distribution match, the object in question is the original object, if they do not match, the object is another object, for example a non-authorized imitation. The porous substructure can be for example a sintered substructure.

The porous substructure can be formed particularly simply and thus advantageously by aiming an energy beam with other parameters than those used for producing the material layers onto the base material (powder or liquid layer). The parameters for producing the porous substructure are preferably varied stochastically, so that a random pore distribution inside the substructure is formed. By way of example the energy density of the energy beam during the production of the porous substructure is varied stochastically, and thus the random pore distribution inside the substructure is formed. Such a stochastic pore distribution is quasi impossible to copy, such that optimum copy protection is ensured.

Additionally or alternatively, another material than that used for the additive production method can be introduced into the object to be marked or into a cavity inside the object to be marked. Preferably a material is used which has another density, another permittivity and/or another permeability. Preferably a magnetic material is used as the marking.

Alternatively or additionally untreated or differently treated base material (for example unmolten or differently melted powder layer material or uncured or differently cured liquid layer material) can be left behind or produced in the object to be marked or in a cavity inside the object to be marked during the additive production method, such that the base material as such forms a marking, for example by way of its density fluctuations. The term base material refers to the material which is used for the additive production method.

Alternatively or additionally a marking in the form of a two- or three-dimensional code can be formed in the object to be marked or in a cavity inside the object to be marked; such a marking is preferably formed during or by the additive production method. By way of example a marking is formed in the form of a barcode and/or a marking with a check digit.

In particular in complex systems and machines such as gas or steam turbines, product forgeries cause great economic damage. Accordingly it is regarded as advantageous if the marking method described is used for components in gas or steam turbines. Preferably produced as marked objects are turbine blades, in particular rotor blades, guide vanes or compressor blades.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an exemplary embodiment for a marked object, on the basis of which different proposed methods are explained by way of example,

FIG. 2 shows an exemplary embodiment of an object, in which a marking is formed by magnetic material,

FIG. 3 shows an exemplary embodiment of an object, in which untreated material was used for marking, which untreated material was used during the additive production method for producing the object, and

FIG. 4 shows an exemplary embodiment of an object, in which the marking is formed by a porous substructure with stochastic pore distribution.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

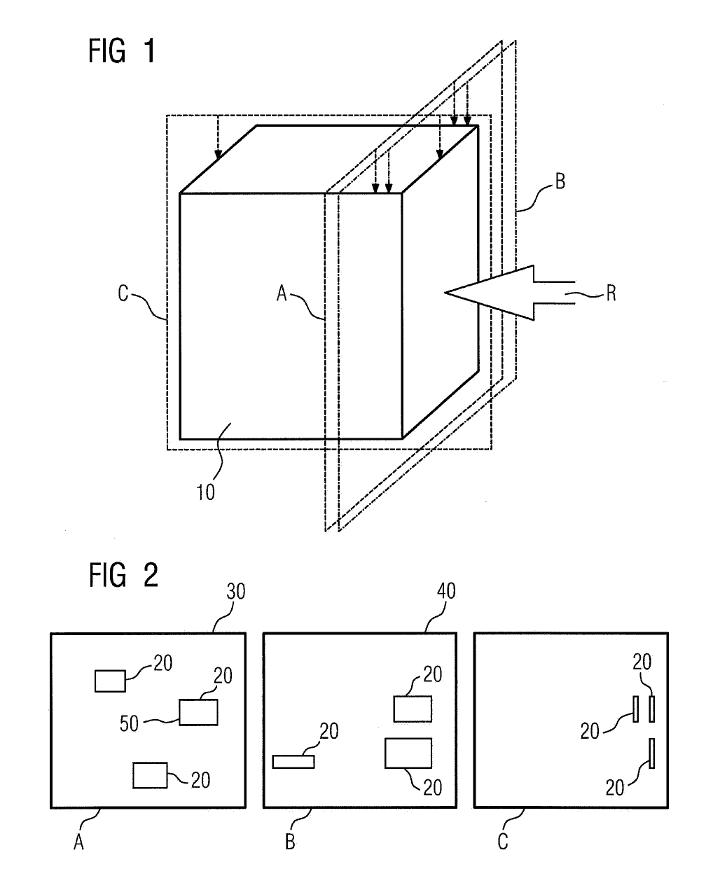

FIG. 1 shows an exemplary embodiment of a marked object which is designated with reference sign 10.

The marked object can be for example a component in a gas or steam turbine, for example a turbine blade.

FIG. 1 illustrates two different cross sections through the object 10 with reference signs A and B. The reference sign C designates a longitudinal section through the object.

If then the marked object 10 is examined along an examination direction R, depending on the examination method or examination type, marking, which are hidden in planes A and B, can be found. On the basis of the marking, it is subsequently possible to determine whether the marked object is an original object or a copy. An examination is carried out for example as to whether the marking matches a marking stored in a database. If a corresponding marking can be found in the database, the object 10 is an original object; if a corresponding marking, however, cannot be found in the database, the object is obviously an unauthorized copy.

FIG. 2 shows an exemplary embodiment for marking the object 10 according to FIG. 1. FIG. 2 shows on the left a material layer 30, which is located in the cross-sectional plane A. In the center of FIG. 2, additionally a material layer 40, which is located in the cross-sectional plane B, can be seen. To the far right, FIG. 2 shows the plane C according to FIG. 1.

During the production of the object 10 according to FIG. 1, that is to say during the application and curing of the material layers 30 and 40, holes or cavities were formed which are designated with the reference sign 20. The cavities 20 were produced by interrupting the manufacturing process during the performance of the additive production method and by removing uncured base material (powder or liquid), which was used during the additive production method, using a suitable apparatus. This removal created the cavities 20.

Before the cavities 20 are completely closed, they were filled entirely or partially with a marking material, for example a magnetic material. The cavities 20 filled in this manner form marking 50 for the object 10. The marking 50 can for example be detected by a magnetic measurement method and be evaluated by a suitable electronic evaluation apparatus.

In summary, the marking 50 in the exemplary embodiment according to FIG. 2 are formed by holes or cavities which are filled entirely or partially with another material, for example a magnetic material.

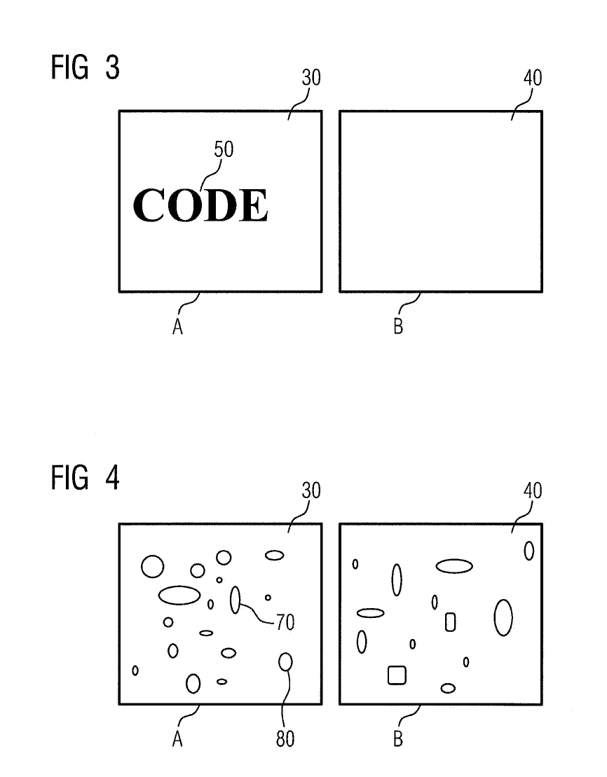

With reference to FIG. 3, a further exemplary embodiment will be explained below for a method for producing the marked object 10 according to FIG. 1. FIG. 3 shows the material layer 30, which is located in the cross-sectional plane A according to FIG. 1. It also shows the material layer 40, which is located in the cross-sectional plane B according to FIG. 1.

In order to form marking 50 for the object 10, base material (powder material or liquid material) was left in the material layer 30 unmolten or uncured in the cross-sectional plane A. Subsequently further material layers were applied onto the material layer 30 during the additive production method, with which further material layers the unmolten powder material or the uncured liquid material was embedded or enclosed as marking 50 in the object 10. A covering or enclosing material layer is formed for example by the material layer 40 in the cross-sectional plane B.

The marking 50, which is formed by uncured or untreated base material (powder or liquid material) of the additive production method, can be configured to be two- or three-dimensional and form a coding, for example in alphanumerical form or as a barcode. Check digits and other keys can also be used as marking 50.

The marking 50 according to FIG. 3 can be detected for example by a measurement-technological detection of density differences, for example at the boundary surfaces at the transition between solid body and powder/liquid, or by detecting different thermal properties between the cured material layers 30 and 40 on the one hand, and the marking 50, which are formed by the untreated base material (powder or liquid), on the other.

Rather than uncured or untreated base material, it is also possible to use differently cured or differently treated base material for marking.

With reference to FIG. 4, it will be explained below how porous substructures can be used for marking the object 10 according to FIG. 1. FIG. 4 also shows the material layer 30, which is arranged in the cross-sectional plane A. In addition it shows the material layer 40, which is located in the cross-sectional plane B.

It can be seen in FIG. 4 that a three-dimensional porous substructure 70 is formed in the material layers 30 and 40, which porous substructure 70 has a multiplicity of individual pores 80. The arrangement of the pores 80 inside the porous substructure 70 is stochastic.

The porous substructure 70 shown in FIG. 4 can be produced by way of example by varying stochastically or deterministically the melting or curing of the base material (powder or liquid) locally during the additive production method for producing the material layers 30 and 40. By way of example the energy density of an energy beam is varied locally for melting or curing the base material.

By way of example a porous substructure can be formed in the form of a sintered substructure by a parameter variation. Such a sintered substructure can be formed by connecting grains of a powder-like base material, which are connected via what is known as sinter necks. Located between the powder grains in such a case are cavities, which typically contain the ambient or process gas used at the time of the production of the object. Such a sintered substructure has an orderless construction, owing to the stochastic distribution of the grains in the bulk powder, so that each object, which is produced using such a method, has a non-reproducible and thus unique identifier.

If the porous substructure 70 shown in FIG. 4 is captured during the production of the object 10 or thereafter using measurement technology and stored for example in electronic form in a database, it is possible at a later date to ascertain at any time whether an object to be examined is exactly this object 10 according to FIG. 1: to this end a search is carried out at the corresponding locations for a pore distribution; if such a pore distribution can be found, it is subsequently compared to the pore distribution stored in the database. If the pore distributions match, the object is an original object, in the other case it is an imitation.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A method for producing a marked object using an additive production method in which the object is built up layer-by-layer, comprising:
producing a cavity during the additive production method;
inserting a gaseous or powder-type marking in the cavity; and
closing the cavity by the additive production method, with the marking enclosed within the cavity.

17. The method as claimed in claim 16, wherein the additive production method produces material layers by a process comprising:
melting a first powder layer locally using an energy beam and subsequently curing a melted powder to form a first material layer; and
applying further powder layers, layer by layer, onto the first material layer, locally melting and then curing each of the further powder layers to respectively form further material layers.

18. The method as claimed in claim 16, wherein the additive production method produces material layers by a process comprising:
curing a first liquid layer locally using an energy beam to form a first material layer; and
applying further liquid layers, layer by layer, onto said first material layer; and
curing each of the further liquid layers locally to respectively form further material layers.

19. The method as claimed in claim 16, wherein a porous substructure is produced in the cavity and a pore distribution of the porous substructure forms the marking.

20. The method as claimed in claim 19, wherein
the additive production method produces material layers by locally using a first energy beam, and
the porous substructure is formed using a second energy beam having different parameters from the first energy beam.

21. The method as claimed in 19, wherein the parameters for producing the porous substructure are stochastically or deterministically varied, such that a random pore distribution inside the porous substructure is formed.

22. The method as claimed in claim 20, wherein
the second energy beam has a different energy density from the first energy beam, and
the energy density of the second energy beam is varied stochastically or deterministically during the production of the porous substructure to form a random pore distribution inside the porous substructure.

23. The method as claimed in claim 16, wherein the marking is a magnetic material inserted in the cavity.

24. The method as claimed in claim 16, wherein the marking is un-melted powder or uncured liquid left inside the cavity.

25. The method as claimed in claim 16, wherein the marking is a two- or three-dimensional code formed in the cavity.

26. The method as claimed in claim 25, wherein the marking is a barcode formed in the cavity.

27. The method as claimed in claim 25, wherein the marking is a check digit formed in the cavity.

28. The method as claimed in claim 16, wherein the marked object is a component of a gas or steam turbine.

29. The method as claimed in claim 28, wherein the marked object is a rotor blade, a guide vane or a compressor blade.
